(19) United States
(12) Patent Application Publication
(10) Pub. No.: US 2018/0117711 A1
(43) Pub. Date: May 3, 2018

(54) LASER COATING PROCESS AND DEVICE THEREFOR

(71) Applicants: PLASMA INNOVATIONS GMBH, Attnang-Puchheim (AT); ECKART GMBH, Hartenstein (DE)

(72) Inventors: Michael BISGES, Regensburg (DE); Ulrich-Andreas HIRTH, Bayreuth (DE)

(21) Appl. No.: 15/568,284

(22) PCT Filed: Apr. 25, 2016
(86) PCT No.: PCT/EP2016/059126

§ 371 Date: Oct. 20, 2017

(30) Foreign Application Priority Data
Apr. 27, 2015 (DE) 102015106464.2

(51) Int. Cl. B23K 26/144; B23K 31/02; C23C 4/02; C23C 24/10

(52) U.S. Cl. CPC B23K 26/144; C23C 24/10; C23C 4/02; B23K 31/02

(57) ABSTRACT

The invention relates to a process for applying a coating material to a surface, comprising the steps of:—providing a stream of gas mixture (8) comprising a carrier gas and a coating material (2),—feeding the stream of gas mixture (8) onto the surface (3a), wherein the stream of gas 12 s mixture (8) impinges on the surface (3a) and the coating material (2) applied there forms an area of impingement (11) on the surface (3a)—coupling at least one laser beam (7) into the stream of gas mixture (8),—wherein the coupled-in energy of the at least one laser beam (7) is determined in such a way that the solid coating material (2) at least partially melts and—wherein each laser beam (7) is directed onto the stream of gas mixture (8) in such a way that the laser beam (7) does not fall on the area of impingement (11) on the surface. The invention also relates to a device for carrying out the process.

The invention relates to a process and a device for applying virtually any desired solid coating material to a surface.

Laser deposition welding, in which a surface application is applied to a surface of a workpiece by applying virtually any desired coating material, is known from the prior art. A laser beam produces a melt bath on the surface of the component, to which the coating material is fed as a powder-gas mixture by means of nozzles. The coating material is in particular a metal powder. Both the surface of the component and the coating material are melted during the laser deposition welding.

A device for laser deposition welding that is disclosed by the brochure “Laserauftragschweißen: Oberflächen optimieren und reparieren [laser deposition welding: optimizing and repairing surfaces].—ident-no. 0375845_201306_F” of the company Trumpf Laser-und Systemtechnik GmbH, D 71254 Ditzingen, has a powder conveyor for providing a stream of powder-gas mixture and also a processing optical unit with a powder nozzle. With the aid of the powder nozzle, the stream of powder-gas mixture previously provided by the powder conveyor is fed to the surface to be coated. The processing optical unit has a disk laser or a diode laser as a source of radiation. The processing optical unit is aligned in such a way that the laser beam impinges on the surface of the workpiece onto which the stream of powder-gas mixture is directed.

Laser deposition welding is only suitable for certain surfaces. In particular in the case of plastics, the high level of energy of the laser beam that is coupled into the surface of the component results in the surface of the component being damaged. Laser deposition welding is therefore only possible on surfaces of high-melting plastics, metals or ceramics.

Against the background of this prior art, the invention is based on the object of providing a process for applying virtually any desired solid coating materials even to temperature-sensitive surfaces that also requires significantly less energy. It is also intended to provide an advantageous device for carrying out the process.

This object is achieved by a process with the features of claim 1 and a device with the features of claim 24.

The coupling of the at least one laser beam into the stream of gas mixture preferably takes place directly before the impingement of the stream of gas mixture onto the surface. The coupling in has the effect that the energy is transferred from the laser beam to the coating material in the form of solid matter in the stream of gas mixture, the coupled-in energy of the at least one laser beam being determined in such a way that the solid coating material at least partially melts.

Each laser beam is directed onto the stream of gas mixture in such a way that the laser beam does not impinge on the area of impingement of the coating material applied to the surface. This has the effect that the energy of the laser beam is not transferred directly to the surface and the thermal loading of the surface is reduced considerably in comparison with laser deposition welding. The lower thermal loading of the surface allows the coating of heat-sensitive materials by the process according to the invention. Preferably, each laser beam is aligned in relation with the surface in such a way that the laser beam does not impinge on the surface at any point. This can be achieved for example by a parallel or upwardly inclined alignment of the laser beam in relation to the surface.

The coating material in the form of solid matter in the stream of gas mixture is partially melted only by the coupled-in energy of the at least one laser beam. The coating process can therefore only be controlled with the aid of the laser or the lasers, for example by switching off the laser power, shutting off the laser beam or by deflecting the laser beam in such a way that for a time it is not directed onto the stream of gas mixture. At least the surface of the particles of the solid coating material is melted by the coupled-in energy of the at least one laser beam, in order to produce a firmly adhering coating.

As a result of the direct coupling of the laser beam into the stream of gas mixture and the not required melting of the surface of the component, the required laser power of the process according to the invention is considerably lower in comparison with laser deposition welding. In order to melt a mass flow of a coating material (copper) of for example 10 g/min only with the aid of laser radiation in such a way that an adhesive attachment occurs for example on a surface of a plastic or on a layer of the coating material that has previously been deposited, a laser power of 10 watts is already sufficient.

According to the invention, the coating material may be applied just locally or else over a large area. For a coating over a large area, with an area of impingement of the applied coating material that is greater than the cross section of the stream of gas mixture, the surface and the stream of gas mixture are moved in relation to one another during the application. The relative movement may be produced by moving the surface to be coated and/or by moving the feeding element for the stream of gas mixture.

The stream of gas mixture, provided in particular by a powder conveyor, comprises the solid coating material. Pure metals or alloys are used in particular as coating materials for producing electrically or thermally conductive coatings. In addition, the process is also suitable however for applying plastics, glass or ceramic as coating materials. The coating materials preferably take the form of powder. In order to couple the energy of the laser radiation into the coating materials effectively, the wavelength of the laser radiation must be made to match the absorption spectrum of the coating material.

If an adhesive attachment of the applied coating material is desired, the surface to which the coating material is applied preferably has adhesion-promoting properties for the coating material. Particularly advantageous adhesion-promoting materials are for example:
polyamide,
PC-ABS (polycarbonate acrylonitrile butadiene styrene),
PPS (polybutylene terephthalate),
thermosets

The above materials may take the form of pure polymers or compounds with fillers. Glass, ceramic or metals come into consideration for example as fillers. Fillers account for a maximum of 30% by weight of the compound.

In order to improve the adhesive attachment of the coating material on the surface of an article, in an advantageous refinement of the invention at least the top layer of the article that has the surface may have undercuts.

According to the invention, the at least one laser beam is produced continuously by means of a continuous wave laser or discontinuously by means of a pulsed laser. On account of the high peak intensities, the pulsed laser is used in particular for coating materials with higher melting temperatures.

If the at least one laser beam is coupled into the stream of gas mixture in a focused manner, the concentration of the radiation brings about a high energy density in the coupling-in area. With a defocused laser beam, a greater coupling-in area into the stream of gas mixture can be produced.

In order to increase the coupling-in area of a laser beam, in particular a focused laser beam, into the stream of gas mixture, in a refinement of the invention the alignment of the laser beam is changed during the coupling of the at least one laser beam into the stream of gas mixture. In the case of a defocused laser beam, the alignment can generally be kept unchanged during the coupling of the laser beam into the stream of gas mixture.

A structured application of the coating material to the surface can take place in an easy way by the coupling in of the at least one laser beam being interrupted for a time during the feeding of the stream of gas mixture.

This has the effect that the transfer of energy to the coating material is interrupted for a time, and as a result the coating material that is fed during the interruption is not melted. In conjunction with a relative movement between the surface and the stream of gas mixture, interruption of the coupling in can have the effect of creating areas on the surface in which the coating material does not adhere.

To interrupt the coupling in for a time, the laser power may be switched off, the laser beam shut off with a shutter or deflected by a laser optical unit in such a way that for a time it is not directed onto the stream of gas mixture.

Providing the stream of gas mixture comprising the carrier gas and the solid coating material takes place with the aid of a powder conveyor. The powder conveyor comprises as a conveying device for example a disk conveyor, a vibration conveyor or a powder pump, with which the powdered coating material is introduced into the stream of carrier gas. An inert gas, such as for example argon, nitrogen or ambient air are suitable for example as the carrier gas. The carrier gas is provided with a volumetric flow in the range from 1 to 50 l/min, preferably 1-20 l/min. The conveying device of the powder conveyor feed the coating material to the carrier gas with a mass flow in the range from 0.1 g/min to 100 g/min, preferably 2 g/min to 20 g/min. The powdered coating material that is fed preferably has a grain size distribution of 100 nm to 120 μm.

The stream of gas mixture formed in such a way is passed via lines to a feeding element with an outlet, the outlet preferably being kept at a vertical distance from the surface in the range from 1 mm to 100 mm. The feeding element is directed with the outlet onto the surface in such a way that the stream of gas mixture preferably impinges on the surface perpendicularly.

If a hollow needle that has an inside diameter in the range from 0.1 to 10 mm is used as the feeding element, a quasi laminar flow of the powder-gas mixture is produced at the outlet by the great length of the hollow needle in relation to the inside diameter. With the aid of the quasi laminar stream of gas mixture, precise structures can be deposited on the surface.

If wider traces are to be deposited on the surface, in particular for a coating over a full surface area, the stream of gas mixture is preferably fed via a diffuser, which accelerates the stream of gas mixture at the outlet and produces a stream of gas mixture that widens in the direction of the area of impingement.

The laser beam is preferably coupled into the stream of gas mixture directly before the impingement of the stream of gas mixture on the surface, in order to keep the energy losses on the way from the outlet of the feeding element to the surface low. Depending on the distance of the outlet of the feeding element from the surface, the laser beam is coupled into the stream of gas mixture at a distance of 0.1 mm to 50 mm above the surface. If the distance of the outlet of the feeding element from the area of impingement changes during the application of the coating material, the laser power is preferably raised as the distance becomes greater and lowered as the distance becomes less.

With the process according to the invention, not only can coatings be applied to a surface but also three-dimensional objects can be produced as a surface application. For this purpose, a number of layers of the coating material are deposited one on top of the other. The layer previously deposited in each case forms the surface to which the stream of gas mixture is fed in the next operation. The layers deposited one after the other may consist of different coating material. For example, first individual layers of a polymer may be deposited, onto which conductive tracks of metallic coating material, for example copper, are then deposited. Subsequently, further layers of polymeric coating material may be built up, in order to produce a complex component with an integrated interconnect structure. In this way, lead frames that are comparable to an MID component can be built up by the process according to the invention.

In a refinement of the process according to the invention, a surface can be coated in a structured manner by providing that, before the feeding of the stream of gas mixture, the surface is partially provided with a top layer that has anti-adhesive properties with respect to the fed coating material. The stream of gas mixture is preferably directed onto the surface with a widened flow cross section. The top layer has the effect that the coating material bonds in firmly adhering manner only to the other areas of the surface, not the areas provided with the top layer. The surface may for example be partially provided with a top layer by the top layer that is initially applied over the full surface area being removed again in some areas. The removal takes place for example by way of laser ablation. According to the invention, top layers with anti-adhesive properties are applied to the surface in a layer thickness of 1 μm to 500 μm.

A structured application of the coating material to the surface may be achieved in a further refinement of the invention by the substrate or the article having portions with adhesion-promoting properties and portions with anti-adhesive properties. The coating material applied to the surface may adhere just in those portions that consist of adhesion-promoting materials.

A structured application of the coating material to the surface may be achieved in a further refinement of the invention by the surface or the article to be coated consisting at least in certain portions of a sacrificial material, the sacrificial material having anti-adhesive properties with respect to the coating material that is subsequently fed with the stream of gas mixture. On account of the input of energy by the stream of gas mixture, the sacrificial material releases gaseous constituents, which prevents an adhesive attachment of the coating material to the surface. A structured application of the coating material takes place by providing that, before the application, the surface consisting of sacrificial material is removed or passivated in some areas, for example by means of a laser. The removal has the effect that a surface with adhesion-promoting properties that is located under the sacrificial material is exposed. The passivation has the effect that the surface consisting of the sacrificial material becomes adhesion-promoting without being removed completely. The passivation and removal of the sacrificial material takes place by selective input of energy. Alternatively, the sacrificial material may be applied to an adhesion-promoting surface in a form that is already structured by means of printing processes or masking.

The sacrificial material that can be used for producing a top layer or a portion of an object preferably comprises at least one of the following materials:
polycarbonate,
polyacrylic,
UV-curing lacquers that comprise inter alia acrylic monomers.

The sacrificial material with anti-adhesive properties preferably contains chemical substances that comprise an acrylic group (CH₂═CH—COR). Even from a proportion of the acrylic groups in a polymer of only 1 percent by weight, the anti-adhesive properties of the sacrificial material are evident.

The invention is explained in more detail below on the basis of the figures, in which:

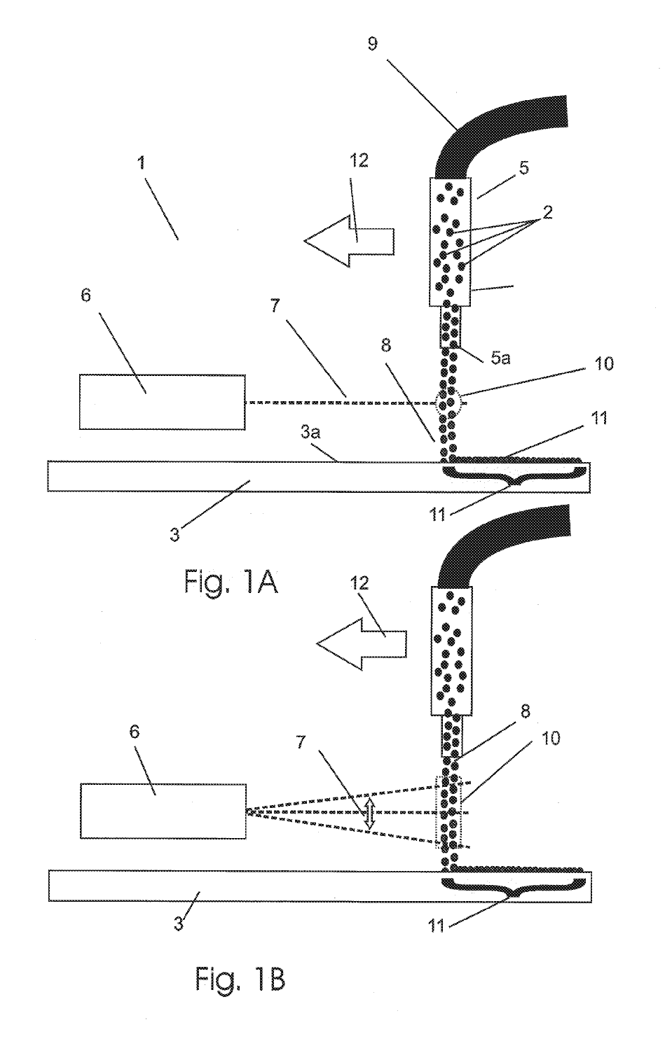

FIG. 1A shows a first exemplary embodiment of a device for applying a powdered coating material to a surface of a substrate,

FIG. 1B shows a second exemplary embodiment of a device for applying a powdered coating material to a surface of a substrate,

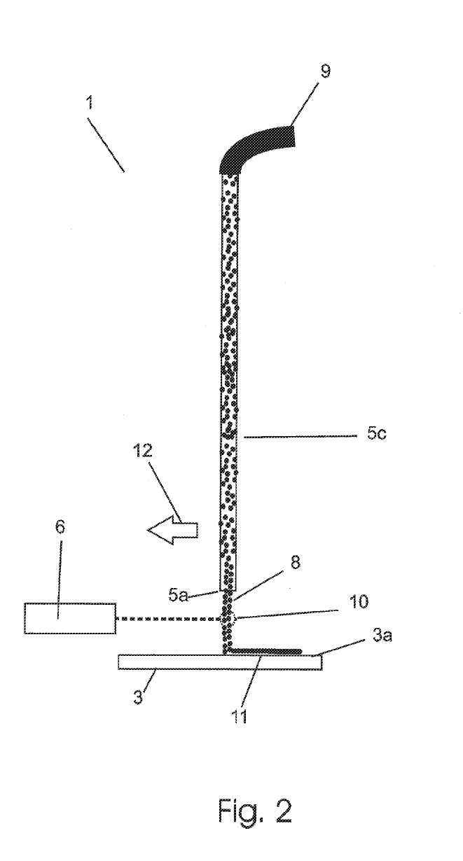

FIG. 2 shows a device corresponding to FIG. 1A with a feeding element configured as a hollow needle,

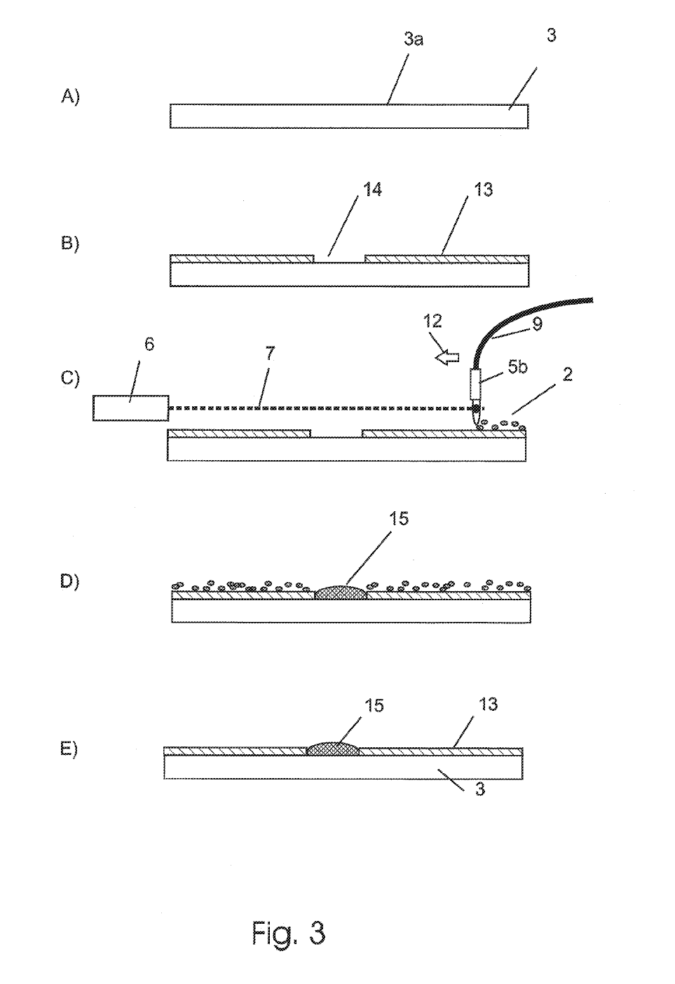

FIGS. 3 A-E show a schematic representation to illustrate a process for applying a powdered coating material to a surface of a substrate that is partially provided with a top layer,

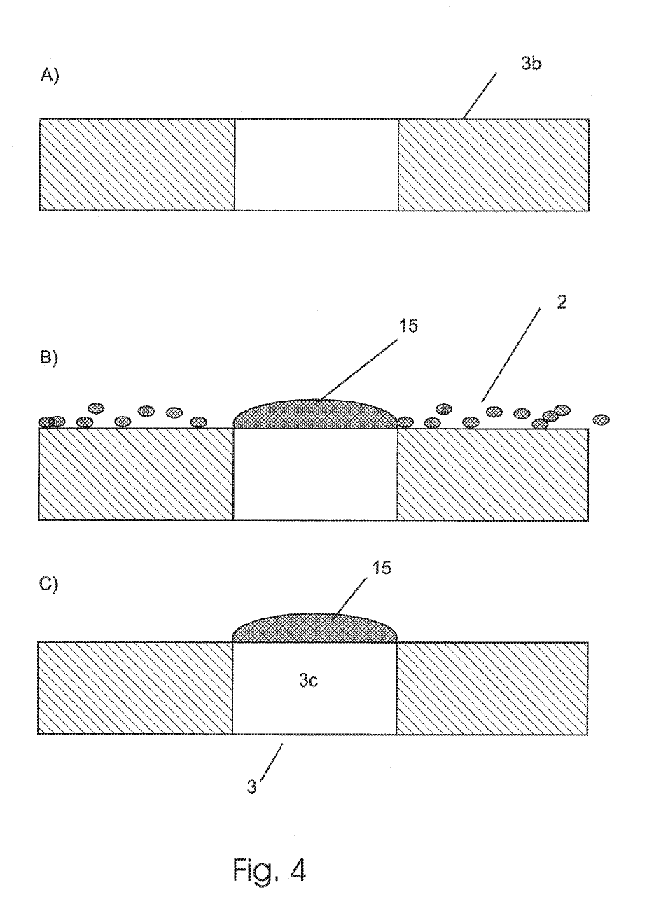

FIGS. 4 A-C show a schematic representation to illustrate a process for applying a powdered coating material to a surface with different material properties,

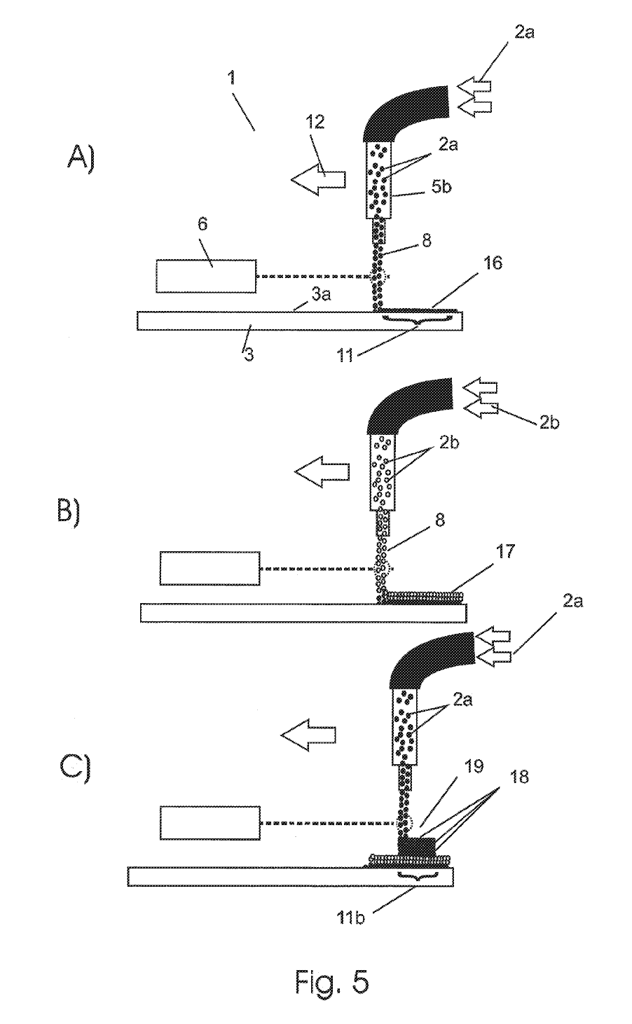

FIGS. 5 A-C show a schematic representation to illustrate a process for producing a three-dimensional article,

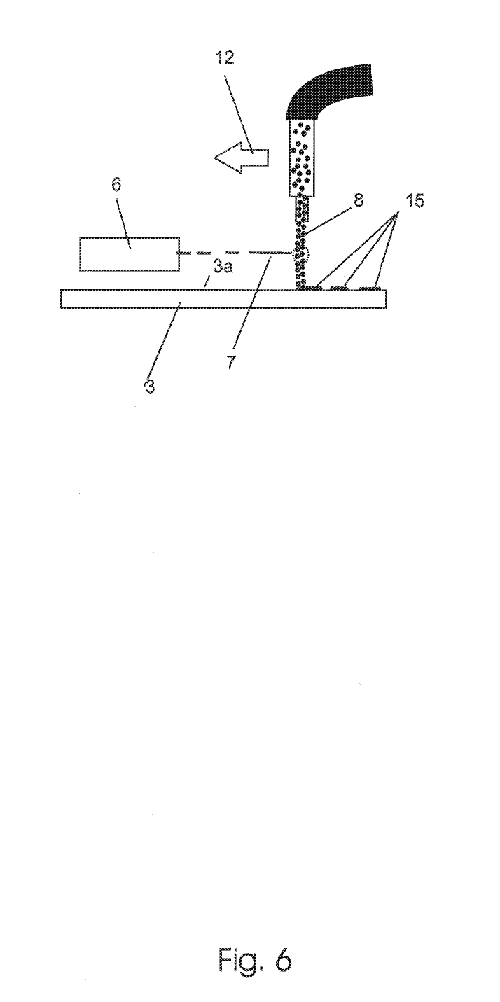

FIG. 6 shows a schematic representation to illustrate a process for the structured application of coating materials to the surface of a substrate,

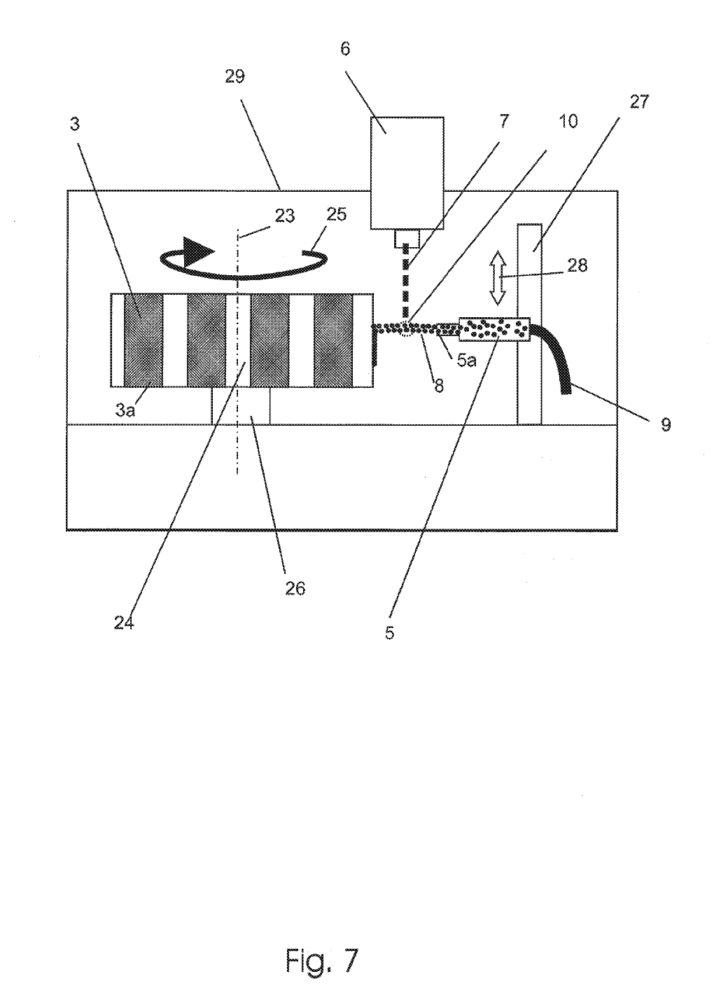

FIG. 7 shows a preferred device for applying a powder coating material to a number of substrates and

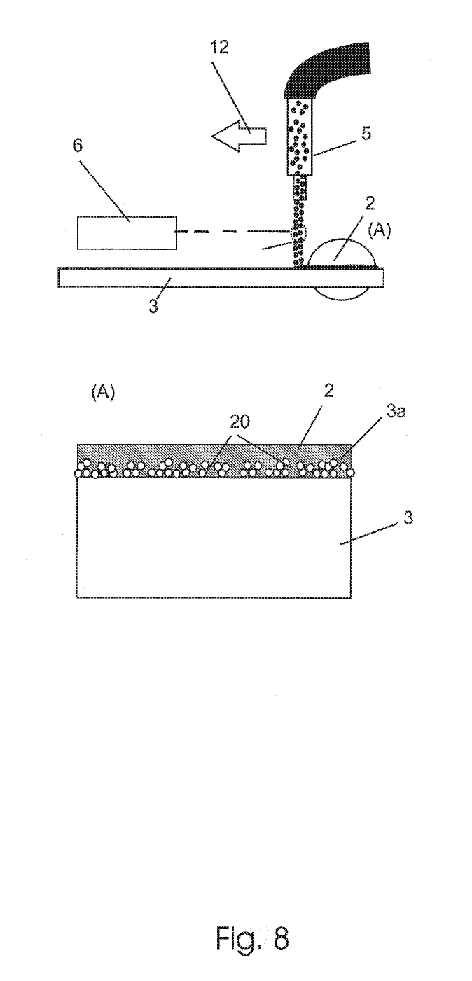

FIG. 8 shows a representation to illustrate a surface of a substrate that has undercuts.

The device (1) schematically represented in Figure la for applying a powdered coating material (2) to a surface (3a) of a substrate (3) consists essentially of a powder conveyor (4) that is just partially represented, a feeding element (5) that is configured as a powder nozzle (5b) and also a laser (6) for producing a laser beam (7) parallel to the surface (3a) of the substrate (3).

The powder conveyor (4) comprises a powder pump (not represented), which introduces the powdered coating material (2) from a container into a stream of carrier gas. The stream of gas mixture (8) is fed to the powder nozzle (5b) via a feed line (9). The outlet (5a) of the powder nozzle (5b) is directed onto the surface (3a) of the substrate (3) and is at a vertical distance of approximately 50 mm. The powder nozzle (5b) is movable with the aid of a handling system (not represented) in and counter to the direction of the arrow (12) parallel to the surface (3a) of the substrate. The laser (6) is preferably mechanically coupled to the powder nozzle (5b), and therefore likewise moves in the direction of the arrow (12) with respect to the substrate (3), which in the exemplary embodiment as shown in FIG. 1 is kept fixed in place. The coupling-in area (10), in which the laser beam (7) is coupled into the stream of gas mixture (8), is located directly above the surface (3a) of the substrate (3).

It is ensured by the parallel beam guidance of the laser beam (7) that the laser beam (7) does not impinge on the area of impingement (11) of the stream of gas mixture (8) on the surface (3a). As a consequence, in the coupling-in area (10) the energy of the laser beam (7) is only transferred to the powdered coating material (2) in the stream of gas mixture (8). The powdered coating material (2) that has already been at least partially melted in the stream of gas mixture (8) by the effect of the laser beam (7) is applied under pressure to the surface (3a).

The device as shown in FIG. 1B) differs from the device shown in FIG. 1A) essentially in that the laser (6) has a laser optical unit (not represented), which widens the laser beam in the direction of the coupling-in area (10) into the stream of gas mixture (8). This has the effect that the coupling-in area (10) extends over a greater length of the stream of gas mixture (8) between the outlet (5a) of the powder nozzle (5b) and the surface (3a). As a result of the widening, a higher level of energy can be coupled into the powdered coating material (2) by corresponding raising of the laser power of the defocused laser beam (7), in order for example to be able to deposit higher-melting metallic coating materials.

The device (1) as shown in FIG. 2 differs from the device as shown in FIG. 1A) just with regard to the design of the feeding element (5). To avoid repetition, reference is therefore made to the statements made in relation to FIG. 1A) in their entirety. The feeding element (5) is designed as a hollow needle (5c), which has an inside diameter that is small in relation to the length, of less than 10 mm. Forming the feeding element (5) as a hollow needle (5c) has the effect of establishing a quasi laminar flow of the stream of gas mixture (8) between the outlet (5a) and the surface (3a) of the substrate (3).

The application of the powdered coating material (2) to the surface (3a) of a substrate (3) partially provided with a top layer (13) is explained in more detail on the basis of FIG. 3: the surface (3a) of the substrate (3) is provided at each periphery with a top layer (13) (compare FIG. 3b). Between the peripheral portions with the top layer (13), the surface (3a) of the substrate (3a) is exposed in a central area (14). The top layer (13) has anti-adhesive properties with respect to the powdered coating material (2). If therefore the powder nozzle (5b) is moved in the direction of the arrow (12) parallel to the surface (3a) of the substrate (3) that is partially provided with the top layer (13), as is indicated in FIG. 3C), the powdered coating material (2) does not adhere on the top layer (13) on account of the anti-adhesive properties. As can be seen from FIG. 3D), in the central area (14) however the powdered coating material (2) forms a firmly adhering layer (15) on the surface (3a) of the substrate (3). After ending the application of the coating material (2), the surface is cleaned. FIG. 3E) finally shows the cleaned substrate (3), selectively coated just in the central area (14).

FIG. 4 shows an inhomogeneous substrate (3) with portions (3b), which consist of an anti-adhesive material with respect to the powdered coating material (2), and a portion (3c) arranged inbetween, which consists of an adhesion-promoting material with respect to the powdered coating material (2). As a consequence of the adhesion-promoting or anti-adhesive properties of the portions (3c, 3b), on the surface (3a) of the substrate (3) no firmly adhering bond between the coating material (2) and the surface is created in the portions (3b). On the central portion (3c) however there forms a firmly adhering layer (15) of the coating material (2). After ending the application of the coating material (2), the surface of the portions (3b) is freed of the applied coating material (2). FIG. 4 C) finally shows the cleaned substrate (3), which is just selectively coated in portion (3c).

FIG. 5 schematically illustrates a process for applying different coating materials (2a, 2b), which are deposited one after the other in a number of layers one on top of the other. The device (1) for applying the coating material largely corresponds to the device as shown in FIG. 1A). However, the powder conveyor (4) (not represented) has two powder containers, from which the powder pump alternately introduces the first or second coating material (2a, 2b) into the stream of carrier gas. The stream of gas mixture (8) therefore optionally comprises the first or second coating material (2a, 2b).

FIG. 5A) shows how the surface (3a) of the substrate (3) is first coated with the first coating material (2a) in the area of impingement (11) by relative movement of the powder nozzle (5b) in the direction of the arrow (12). Subsequently, as represented in FIG. 5B), a second layer (17) with the second coating material (2b) is applied to the surface of the first layer (16) of the first coating material (2a). Finally, as shown in FIG. 5C), four third layers (18) with the first coating material (2a) are applied to the surface of the second layer (17) by repeatedly moving the powder nozzle (5b) back and forth in a smaller area of impingement (11b).

The first and second coating materials (2a, 2b), which are melted by the laser beam (7) during the application, enter into a firmly adhering bond with one another, so that the article (19) that can be seen in FIG. 5C) can be created with the aid of the process according to the invention.

Depending on the nature of the surface of the substrate (3), the first layer (16) bonds with the surface (3a) or does not enter into a firmly adhering bond with it. In the latter case, the surface (3a) just serves as a temporary support for the production of the article (19). If, however, a permanent adhesive attachment of the coating material (2) to the surface is desired, it is recommendable to roughen the surface in a way corresponding to FIG. 8, causing the formation of undercuts (20), in which the coating material (2) can become enmeshed, as can be seen from the enlargement A.

Usually, articles that are created by means of molding, extruding or compression-molding processes have smooth surfaces with low roughness and no undercuts. If adhesive attachment of the coating material to the surface of the article is desired, the mechanical interlocking of the at least partially melted coating material in the undercuts of the surface represents an essential adhering mechanism. It is therefore meaningful to fashion the surface in such a way that undercuts of an order of magnitude of 0.1 μm-100 μm occur repeatedly and distributed over the surface. For this purpose, a roughening of the surface, and simultaneous formation of micro undercuts, can be created in the areas of the surface with adhesion-promoting properties, for example by means of a laser.

Alternatively, for example in a first process step, an adhesion-promoting, ceramic coating with undercuts may be deposited on the smooth surface of the article. For this purpose, powdered ceramic coating material is incipiently melted and deposited on the surface by means of a plasma coating process. The choice of suitable powder particle sizes (1-50 μm) and coating parameters allows undercuts to be selectively created on the surface, by the particles not melting completely but remaining intact in the core. The accumulation on the surface of partially round, irregular or undefined powder particles leads to an open-pore formation with numerous undercuts. Such ceramic, adhesion-promoting layers are preferably applied to the surface in thicknesses of 1-500 μm. The coating material that is then applied to the ceramic, adhesion-promoting layer by the process according to the invention becomes mechanically enmeshed in the undercuts.

The application of the powdered coating material (2) that is structured in certain portions by a device as shown in FIG. 1A) is explained on the basis of FIG. 6: During the continuous feeding of the stream of gas mixture (8), the laser beam (7) is interrupted for a time, which takes place for example by switching the laser power on and off. While the laser (6) is switched on and the laser beam (7) is being coupled into the stream of gas mixture (8), the coating material (2) is deposited in a firmly adhering manner on the surface (3a) of the substrate (3).

In the phases of interruption of the laser (6), coating material (2) is still applied to the surface (3a). Since, however, no laser energy is being coupled into the coating material (2), this material is not melted, and therefore does not bond to the surface (3a) in a firmly adhering manner. Periodic switching on and off produces the sequence of firmly adhering layers (15) that can be seen from FIG. 6 after the removal of the not firmly adhering coating material (2).

A preferred device (1) for carrying out the process according to the invention is described below on the basis of FIG. 7. The device (1) has a turntable (24), which is rotatable about an axis of rotation (23). In order to set the turntable (24) in rotation about the axis of rotation (23), in the direction and counter to the direction of the arrow (25), the turntable (24) has a drive (26). Detachably fastened to the outer circumference of the turntable (24) are substrates (3) with an outwardly facing surface (3a).

The device (1) also has a linear system (27), for example a driven linear slide, which can move the feeding element (5) in the direction of a linear axis of displacement (28). The outlet (5a) of the feeding element (5) is directed onto the surface (3a) of one substrate (3) after the other, in order that the stream of gas mixture (8) can be fed to the substrate surface (3a). The feeding element (5) is arranged on the linear system (27) in such a way that the stream of gas mixture (8) impinges on the surface (3a) of each substrate (3) perpendicularly. The axis of displacement (28) runs parallel to the axis of rotation (23) of the turntable (24). Displacing the feeding element (5) in and/or counter to the axis of displacement (28) therefore allows the coating material (2) to be applied in the form of strips to the substrate (3) that is positioned in each case with respect to the outlet (5a) of the feeding element (5) with the aid of the turntable. If the coating cannot be applied to the substrate (3) with one trace, a number of vertical traces can be applied next to one another by the turntable (24) being turned slightly after the application of each trace.

The laser (6) may be arranged fixed in place, as represented in FIG. 7, or on a handling device. The laser optical unit is aligned in such a way that the laser beam (7) impinges on the stream of gas mixture (8) perpendicularly in the coupling-in area (10).

The device (22) is finally surrounded by an enclosure (29) to form a working space. The drive both of the turntable (24) and of the linear system (27) and also the laser (6) are program-controlled, in order to ensure a fully automatic coating of substrates (3).

A number of cases of how the process according to the invention is used are given below by way of example:
1. In the electronics industry, the process can be used for depositing structured conductor tracks on three-dimensional bodies, in particular of plastic and ceramic. In addition, the process is used for depositing structured conductor tracks on planar printed circuit boards.
2. In the semiconductor industry, the process can be used for depositing porous metal layers on wafers, for example for producing IGBT modules. In addition, with the process according to the invention, contacts between semiconductors and supporting bodies can be established as a substitute for bonding connections.
3. In particular in medical technology, the process can also be carried out in evacuated working spaces, in order for example to produce medically effective coatings for implants with the exclusion of the atmosphere.
4. In the area of photovoltaics, electrically conductive contact structures and/or semiconductor materials can be deposited on the solar cells by the process according to the invention.
5. In the area of display production, for example conductive structures can be deposited by the process according to the invention on the surface of glasses for producing displays.
6. In industrial reel-to-reel coating processes, for example film webs and sheets can be provided with porous metal layers, which are applied by means of a preferably widening stream of gas mixture.

| No. | Designation |
|---|---|
| 1. | Device |
| 2. | Coating material |
| 2a. | First coating material |
| 2b. | Second coating material |
| 3 | Substrate |
| 3a. | Surface |
| 3b. | Substrate portion |
| 3c. | Substrate portion |
| 4. | Powder conveyor |
| 5. | Feeding element |
| 5a. | Outlet |
| 5b. | Powder nozzle |
| 5c. | Hollow needle |
| 6. | Laser |
| 7. | Laser beam |
| 8. | Stream of gas mixture |
| 9. | Feed line |
| 10. | Coupling-in area |
| 11/11b. | Area of impingement |
| 12. | Arrow |
| 13. | Top layer |
| 14. | Central area |
| 15. | Firmly adhering layer |
| 16. | First layer |
| 17. | Second layer |
| 18. | Third layer |
| 19. | Article |
| 20. | Undercuts |
| 21. | — |
| 22. | Device |
| 23. | Axis of rotation |
| 24. | Turntable |
| 25. | Arrow |
| 26. | Drive |
| 27. | Linear system |
| 28. | Axis of displacement |
| 29. | Enclosure |

1-27. (canceled)

28. A process for applying a coating material to a surface comprising the steps of:
providing a stream of gas mixture comprising a carrier gas and a solid, powdered coating material;
feeding the stream of gas mixture to the surface, the stream of gas mixture impinging on the surface and the coating material applied to the surface forming an area of impingement on the surface,
moving the surface and the stream of gas mixture relative to one another during the feeding of the stream of gas mixture to the surface;
coupling at least one laser beam into the stream of gas mixture, the coupling in of the at least one laser beam being interrupted for a time during the feeding of the stream of gas mixture,
wherein an amount of the coupled-in energy of the at least one laser beam is set such that the coating material is at least partially melted by the at least one laser beam,
each of said at least one laser beam being directed onto the stream of gas mixture such that the laser beam does not impinge on the area of impingement on the surface,

29. The process as claimed in claim 28, wherein the coating material is partially melted only by the coupled-in energy of the at least one laser beam.

30. The process as claimed in claim 29, wherein at least a surface of the powder particles melts.

31. The process as claimed in claim 28, wherein the at least one laser beam is coupled in continuously by a continuous wave laser or discontinuously by a pulsed laser.

32. The process as claimed in claim 31, wherein the at least one laser beam is coupled in as focused or defocused by a laser optical unit.

33. The process as claimed in claim 28, wherein, during the coupling of the at least one laser beam into the stream of gas mixture, the alignment of each of the at least one laser beam is kept unchanged.

34. The process as claimed in claim 28, wherein, during the coupling of the at least one laser beam into the stream of gas mixture, the alignment of each of the at least one laser beam is changed.

35. The process as claimed in claim 28, wherein the stream of gas mixture is provided with a volumetric flow of the carrier gas in the range from 1-50 l/min

36. The process as claimed in claim 28, wherein the stream of gas mixture is provided with a volumetric flow of the carrier gas in the range from 1-20 l/min.

37. The process as claimed in claim 28, the stream of gas mixture is provided with a mass flow of the coating material in the range from 0.1 g/min-100 g/min.

38. The process as claimed in claim 28, wherein the stream of gas mixture is provided with a volumetric flow of the carrier gas in the range from 2 g/min-20 g/min.

39. The process as claimed in claim 28, wherein the carrier gas is an inert gas, nitrogen or ambient air.

40. The process as claimed in claim 28, wherein the coating material has a grain size distribution of 100 nm to 120 μm.

41. The process as claimed in claim 28, wherein the feeding of the stream of gas mixture is performed using a feeding element with an outlet for the stream of gas mixture, the outlet being kept at a vertical distance from the area of impingement in the range from 1 mm-100 mm.

42. The process as claimed in claim 28, wherein the feeding of the stream of gas mixture is performed using a hollow needle with an inside diameter in the range from 0.1-10 mm.

43. The process as claimed in claim 28, wherein the feeding of the stream of gas mixture is performed using a diffuser, which widens the flow cross section of the stream of gas mixture.

44. The process as claimed in claim 28, wherein the surface with the area of impingement is a component part of a substrate,

45. The process as claimed in claim 28, wherein a plurality of layers of the coating material are deposited one on top of the other,

46. The process as claimed in claim 28, wherein the surface with the area of impingement has undercuts.

47. The process as claimed in claim 28, further comprising, before the feeding of the stream of gas mixture, at least partially providing the surface with a top layer with anti-adhesive properties with respect to the coating material that is subsequently fed with the stream of gas mixture.

48. The process as claimed in claim 28, wherein the surface or an article that has the surface includes at least in certain portions a sacrificial material, the sacrificial material having anti-adhesive properties with respect to the coating material that is fed with the stream of gas mixture.

49. The process as claimed in claim 48, wherein the sacrificial material comprises at least one acrylic group (CH₂═CH—COR), the proportion of the acrylic group preferably being at least 1 percent by weight of the sacrificial material.

50. A device for applying a coating material to a surface for carrying out the process as claimed in claim 1, the device comprising:
a powder conveyor configured to provide a stream of gas mixture comprising a carrier gas and a coating material,
a feeding element for feeding the stream of gas mixture to the surface, the feeding element being configured so that the stream of gas mixture impinges on the surface and the coating material applied on the surface forms an area of impingement on the surface,
a laser producing a laser beam, the lase configured to couple the laser beam into the stream of gas mixture,
the laser beam being aligned in relation to the stream of gas mixture such that the laser beam does not impinge on the area of impingement on the surface,
a handling system configured to produce a relative movement between the feeding element and the surface to be coated, and
means for interrupting the coupling of the laser beam into the stream of gas mixture for a time, by one of shutting off the laser beam with a shutter or deflecting the laser beam with a laser optical unit such that for a time the laser beam is not directed onto the stream of gas mixture.

51. The device as claimed in claim 50, wherein the handling system includes:
a turntable,. which is rotatable about an axis of rotation and is configured to receive at least one object having the surface to be coated; and
a linear system configured to pruduce a linear movement of the feeding element in the direction of an axis of displacement,
wherein the axis of displacement is parallel to the axis of rotation.

52. The device as claimed in claim 51, wherein at least one of:
the laser includes a laser optical unit set up for aligning the laser beam and
the laser is arranged on a handling device configured to align the laser beam.
